(19) United States
(12) Patent Application Publication
(10) Pub. No.: US 2025/0220337 A1
(43) Pub. Date: Jul. 3, 2025

(54) OPEN-BACK HEADPHONE

(71) Applicant: GuoGuang Electric Company, Ltd, Guangzhou (CN)

(72) Inventors: Xintai Geng, Guangzhou (CN); Dezhi Huand, Guangzhou (CN); Weixing Cen, Guangzhou (CN); Zhenhua Liu, Guangzhou (CN)

(21) Appl. No.: 19/086,573

(22) Filed: Mar. 21, 2025

(30) Foreign Application Priority Data
Feb. 17, 2025 (CN) 2025101772892

(51) Int. Cl. H04R 1/28; H04R 1/10; H04R 1/32

(52) U.S. Cl. CPC H04R 1/2888; H04R 1/1016; H04R 1/2849; H04R 1/323; H04R 2460/11

(57) ABSTRACT

An open-back headphone includes a housing and a circuit board. The housing is provided with a guide portion that can right face an ear hole and guide a sound wave toward an ear. The interior of the housing is separated into a front cavity facing the guide portion and a rear cavity facing away from the guide portion. The circuit board is located within the rear cavity and separates the rear cavity into a first rear cavity and a second rear cavity, and the first rear cavity is adjacent to the front cavity. The circuit board is provided with a through hole for communicating the first rear cavity with the second rear cavity. The through hole and the second rear cavity form a Helmholtz resonance effect to absorb a resonant sound wave generated by the first rear cavity.

### CROSS-REFERENCE TO RELATED APPLICATION(S)

This application claims priority to Chinese Patent Application No. 202510177289.2, filed Feb. 17, 2025, the disclosure of which is incorporated herein by reference in its entirety.

### TECHNICAL FIELD

The present disclosure relates to the technical field of headphones and, in particular, to an open-back headphone.

### BACKGROUND

At present, common headphones on the market may be divided into open-back headphones, flat-headed non-in-ear headphones, semi-in-ear headphones, in-ear headphones, on-ear headphones, and over-ear headphones by contact with human ears. These headphones have different shapes and different characteristics in terms of comfort, sound quality, and privacy.

With the development of products such as smart glasses, augmented reality (AR), and virtual reality (VR), and the current requirements of users for their ear canal health, hearing protection, and comfort, open-back headphones are becoming more and more popular among users.

Due to the acoustic design of the open-back headphones, serious sound leakage usually exists, resulting in the privacy of users' calls being often not guaranteed. In addition, the serious sound leakage also interferes with others on quiet occasions.

In view of the preceding problems, the current open-back headphones are usually added with sound insulation structures to suppress the sound leakage. However, the manner of suppressing the sound leakage by adding the soundproof structures increases the overall volume of the headphones, thereby affecting the appearance of the headphones and the wearing comfort of the users. In addition, there are some manners in which the sound quality and sound leakage are adjusted by adjusting the leakage of front and rear cavities of the open-back headphones. These manners often cannot balance both the sound quality and anti-sound-leakage performance, so the existing open-back headphones have poor anti-sound-leakage performance.

### SUMMARY

Embodiments of the present disclosure provide an open-back headphone.

An open-back headphone is provided. The open-back headphone includes a housing and a circuit board.

The housing is provided with a guide portion facing an ear canal of a user, and the guide portion is configured to project a sound wave into the ear canal; an interior of the housing is separated into a front cavity facing the guide portion and a rear cavity facing away from the guide portion; and the circuit board is located within the rear cavity and separates the rear cavity into a first rear cavity and a second rear cavity, and the first rear cavity is adjacent to the front cavity; the circuit board is provided with a through hole for communicating the first rear cavity with the second rear cavity, and the through hole and the second rear cavity are configured to form a Helmholtz resonance effect to absorb a resonant sound wave generated by the first rear cavity.

In one or more embodiments, the housing is provided with a first leakage hole communicating with the first rear cavity; a damping mesh is built into the first leakage hole.

In one or more embodiments, N first leakage holes are provided, N≥2, and the plurality of first leakage holes are spaced apart from each other.

In one or more embodiments, the housing is provided with two first leakage holes of the plurality of first leakage holes; when the open-back headphone is in a worn state, one of the two first leakage holes is arranged to face upward, and the other one of the two first leakage holes is arranged to face downward.

In one or more embodiments, the housing includes a top wall and a bottom wall; the guide portion is arranged on the bottom wall, and the first leakage hole is arranged on the top wall.

In one or more embodiments, the housing is provided with a second leakage hole communicating with the second rear cavity; a damping mesh is built into the second leakage hole.

In one or more embodiments, when the open-back headphone is in a worn state, the second leakage hole is arranged to face forward of the user.

In one or more embodiments, the housing includes a top wall and a bottom wall; the guide portion is arranged on the bottom wall, and the second leakage hole is arranged on the top wall.

In one or more embodiments, the second leakage hole is a strip-shaped hole adapted to a streamlined shape of the top wall.

In one or more embodiments, an insertion plate is arranged along an edge of one of the top wall or the bottom wall, and a slot is arranged along an edge of the other one of the top wall or the bottom wall; the insertion plate is inserted into the slot.

### BRIEF DESCRIPTION OF DRAWINGS

FIG. 1 is a view taken from a first viewing angle to illustrate the structure of an open-back headphone according to an embodiment of the present disclosure.

FIG. 2 is a view taken from a second viewing angle to illustrate the structure of an open-back headphone according to an embodiment of the present disclosure.

FIG. 3 is an exploded view of an open-back headphone according to an embodiment of the present disclosure.

FIG. 4 is a sectional view of an open-back headphone according to an embodiment of the present disclosure.

FIG. 5 is a comparison graph of the sound intensity versus the resonant frequency of an open-back headphone with a second rear cavity added and an open-back headphone with only a first rear cavity according to an embodiment of the present disclosure.

### REFERENCE LIST

1 housing
11 guide portion
12 front cavity
13 rear cavity
131 first rear cavity
132 second rear cavity
14 first leakage hole
15 top wall
151 insertion plate
16 bottom wall
161 slot
17 second leakage hole
2 circuit board
21 through hole

### DETAILED DESCRIPTION

The present disclosure is described below in detail in conjunction with the drawings and embodiments. The embodiments described herein are intended to explain the present disclosure and not to limit the present disclosure. In addition, for ease of description, only part, not all, of the structures related to the present disclosure are illustrated in the drawings.

In the description of the present disclosure, terms “joined”, “connected”, and “secured” are to be understood in a broad sense unless otherwise expressly specified and limited. For example, the term “connected” may refer to “securely connected”, “detachably connected”, or “integrated”, may refer to “mechanically connected” or “electrically connected”, may refer to “connected directly” or “connected indirectly through an intermediary”, or may refer to “connected inside two elements” or “an interaction relation between two elements”. For those of ordinary skill in the art, specific meanings of the preceding terms in the present disclosure may be understood based on specific situations.

In the present disclosure, unless otherwise expressly specified and limited, when a first feature is described as “above” or “below” a second feature, the first feature and the second feature may be in direct contact, or the first feature and the second feature may be in contact via another feature between the two features instead of being in direct contact. Moreover, when the first feature is described as “on”, “above”, or “over” the second feature, the first feature is right on, above, or over the second feature, the first feature is obliquely on, above, or over the second feature, or the first feature is simply at a higher level than the second feature. When the first feature is described as “under”, “below”, or “underneath” the second feature, the first feature is right under, below, or underneath the second feature, the first feature is obliquely under, below, or underneath the second feature, or the first feature is simply at a lower level than the second feature.

In the description of this embodiment, orientations or position relations indicated by terms such as “upper”, “lower”, and “right” are based on the drawings. These orientations or position relations are intended only to facilitate description and simplify operations and not to indicate or imply that a device or element referred to must have such particular orientations or must be configured or operated in such particular orientations. Thus, these orientations or position relations are not to be construed as limiting the present disclosure. In addition, terms “first” and “second” are used for distinguishing between descriptions and have no special meanings.

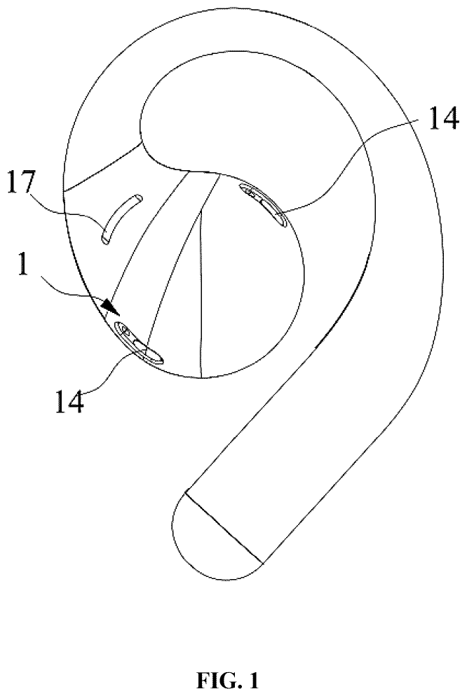

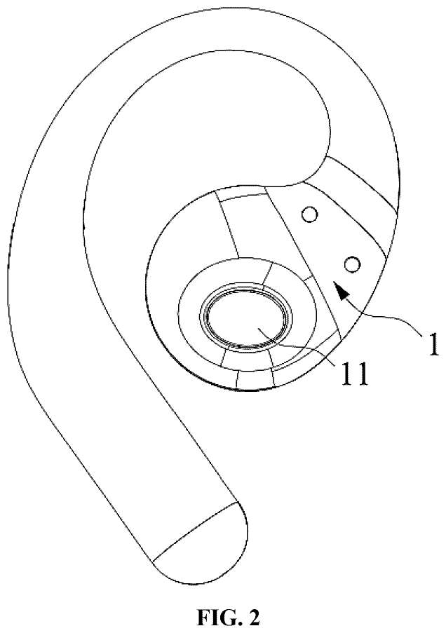

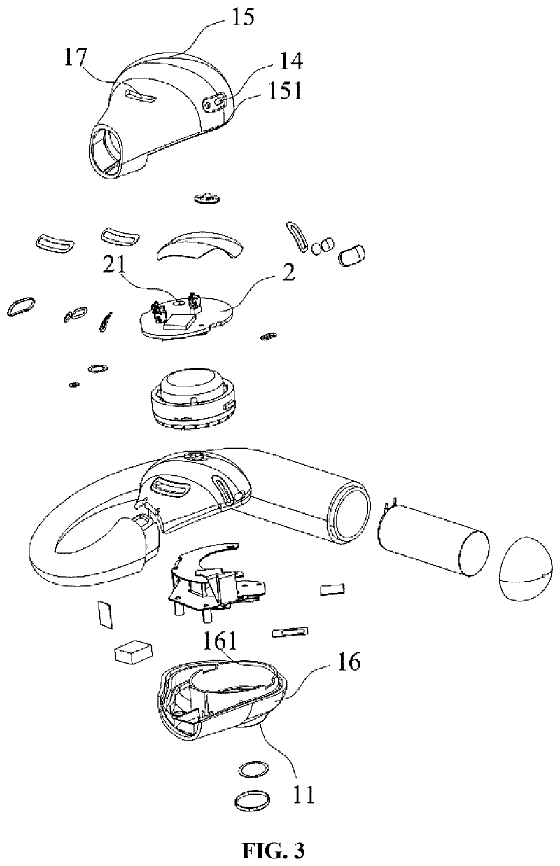

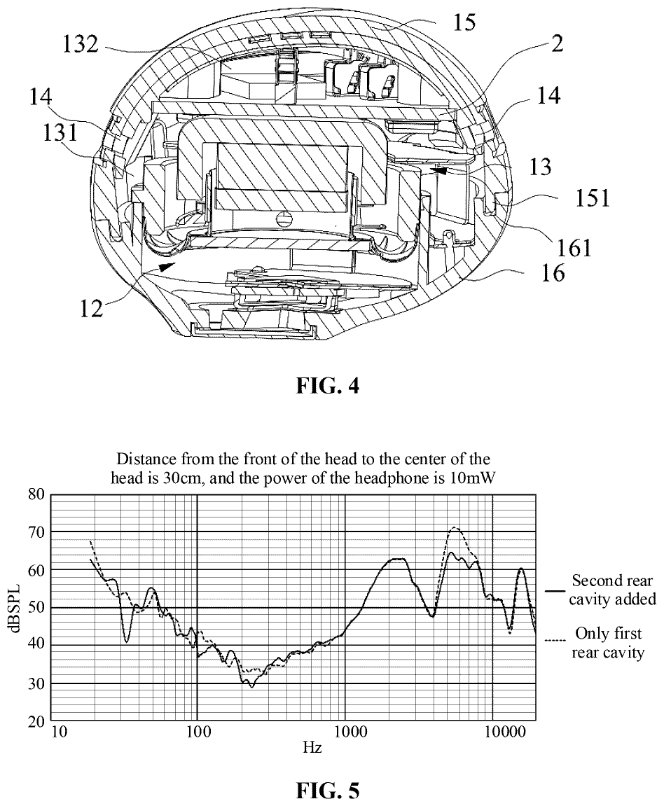

Referring to FIGS. 1 to 4, one or more embodiments relate to an open-back headphone that can suppress sound leakage, balance both the sound quality and anti-sound-leakage performance, and also ensure the compact appearance of the open-back headphone and the wearing comfort of a user. The open-back headphone includes a housing 1 and a circuit board 2. The housing 1 is provided with a guide portion 11 facing an ear canal of a user, and a sound wave is projected into the ear canal through the guide portion 11. The interior of the housing 1 is separated into a front cavity 12 facing the guide portion 11 and a rear cavity 13 facing away from the guide portion 11. The circuit board 2 is located within the rear cavity 13 and separates the rear cavity 13 into a first rear cavity 131 and a second rear cavity 132, and the first rear cavity 131 is adjacent to the front cavity 12. The circuit board 2 is provided with a through hole 21 for communicating the first rear cavity 131 with the second rear cavity 132. The through hole 21 and the second rear cavity 132 form a Helmholtz resonance effect to absorb a resonant sound wave generated by the first rear cavity 131.

In the present disclosure, the space within the housing is separated into the front cavity and the rear cavity, and the circuit board is placed within the rear cavity and further separates the rear cavity into the first rear cavity and the second rear cavity. The circuit board is provided with a cylindrical through hole so that a Helmholtz resonance cavity can be formed in combination with the second rear cavity, thereby effectively absorbing the resonant sound wave generated by the first rear cavity, eliminating the sound leakage peak of the rear cavity in a specific frequency band, reducing the volume of the sound leakage, effectively suppressing the sound leakage, ensuring the privacy of a call using the headphone, and avoiding sound leakage and disturbing others. Moreover, the headphone can also balance both the sound quality and anti-sound-leakage performance. In addition, the first rear cavity and the second rear cavity that are formed by only separating the rear cavity by the circuit board are not required for the introduction of other active sound insulation or silencing structures, so there is no need to increase the thickness and volume of the headphone, thereby ensuring the compact appearance of the headphone and the wearing comfort of the user.

In one or more embodiments, the housing 1 may be formed by injection molding using a non-metallic material, and the outer surface of the housing 1 is smooth and presents a streamlined arc-shaped outer wall surface. As a split structure, the housing 1 includes a top wall 15 and a bottom wall 16 that are interlocked with each other and form an installation space for installing various elements within the housing 1. The internal elements include a speaker, a circuit board 2, and others. The guide portion 11 is arranged on the path of a sound wave of the speaker and used for transmitting the sound wave generated by the speaker to the interior of the ear canal of the user, so as to be recognized by the auditory system. The guide portion 11 is arranged on the bottom wall 16 and includes a sound outlet hole arranged on the bottom wall 16 and an isolation mesh placed within the sound outlet hole.

Within the headphone, the installation space is separated into the front cavity 12 and the rear cavity 13 by the speaker. The front cavity 12 is used for carrying and installing basic structures for sound production, such as the speaker. The rear cavity 13 provides a certain resonant space for the headphone, thereby ensuring the sound quality, especially for the low-frequency sound of the open-back headphone. The structure of the rear cavity 13 noticeably affects the resonance effect. Further, the circuit board 2 is placed within the rear cavity 13 and separates the rear cavity 13 into two portions, namely the first rear cavity 131 and the second rear cavity 132. The circuit board 2 is provided with a cylindrical through hole 21 so that a Helmholtz resonance cavity can be formed in combination with the second rear cavity 132. Based on the Helmholtz sound absorption resonance principle, the resonant sound wave generated by the first rear cavity 131 can be effectively absorbed, the sound leakage peak of the rear cavity 13 in a specific frequency band can be eliminated, the volume of the sound leakage can be reduced, and the sound leakage can be effectively suppressed, thereby ensuring the privacy of a call using the headphone and avoiding sound leakage and disturbing others. Further, referring to FIG. 5, when the headphone only has the first rear cavity 131 retained, a high sound leakage peak is formed at 5 kHz to 7 kHz. When the second rear cavity 132 is added, the resonant frequency of the second rear cavity 132 may be adjusted to about 6 kHz in combination with the adjustment of damping, that is, the sound leakage peak of 5 kHz to 7 kHz may be absorbed specifically, and the maximum suppression of about 8 dB is obtained, which ensures the sound quality while taking into account the anti-sound-leakage performance. In addition, the first rear cavity 131 and the second rear cavity 132 that are formed by only separating the rear cavity 13 by the circuit board 2 are not required for the introduction of other active sound insulation or silencing structures, so there is no need to increase the thickness and volume of the headphone, which can further ensure the compact appearance of the headphone and the wearing comfort of the user.

The contour of the circuit board 2 needs to match the structure of the installation space of the housing 1. In one or more embodiments, the edge of the circuit board 2 is an irregular arc.

In one or more embodiments, the housing 1 is provided with a first leakage hole 14 communicating with the first rear cavity 131, and a damping mesh is built into the first leakage hole 14.

In one or more embodiments, the first leakage hole 14 is arranged on the top wall 15. The arrangement of the first leakage hole 14 and the damping mesh within the first leakage hole 14 may be used for adjusting the Q value of the frequency response at the ear of the user. Exemplarily, a reduction in the damping of the first leakage hole 14 appropriately improves the leakage capacity of the rear cavity 13, that is, the adjustment on the structure and damping value of the first leakage hole 14 can maintain the Q value around 0.7, thereby ensuring the low-frequency performance of the entire headphone in combination with the first rear cavity 131 and the first leakage hole 14.

In one or more embodiments, a damping adjustment member may be placed within or attached outside the first leakage hole 14 to adjust the damping value. Exemplarily, a corresponding damping mesh is attached on the first leakage hole 14.

In one or more embodiments, N first leakage holes 14 are provided, N≥2, and the multiple first leakage holes 14 are spaced apart from each other.

In one or more embodiments, those skilled in the art may reasonably set the number, shapes, and sizes of the first leakage holes 14 according to the low-frequency performance of the open-back headphone to achieve the best sound quality. In addition, the multiple first leakage holes 14 remain spaced apart from each other to prevent the intensity of sound waves projected through the first leakage holes 14 from being weakened due to interference between the sound waves.

Further, the housing 1 is provided with two first leakage holes 14. When the open-back headphone is in a worn state, one of the two first leakage holes 14 is arranged to face upward, and the other one of the two first leakage holes 14 is arranged to face downward.

In one or more embodiments, the two first leakage holes 14 are arranged on the top wall 15 and are symmetrical. When the headphone is in the worn state, one of the two first leakage holes 14 is arranged to face upward, and the other one of the two first leakage holes 14 is arranged to face downward so that the headphone can keep high-frequency sound leakage away from the crowd to the greatest extent in the horizontal direction and prevent high-frequency sound waves from coming out directly along the horizontal path, thereby ensuring the privacy of the headphone in use and avoiding interference with others.

In one or more embodiments, the housing 1 is provided with a second leakage hole 17 communicating with the second rear cavity 132, and a damping mesh is built into the second leakage hole 17.

In one or more embodiments, the second leakage hole 17 is also arranged on the top wall 15. The second leakage hole 17 in combination with the damping mesh of the second leakage hole 17 can adjust the absorption frequency and bandwidth of the second rear cavity 132. Appropriate adjustment on the damping value of the second leakage hole 17 can adjust the absorption frequency and bandwidth of the second rear cavity 132 so that the headphone can achieve the optimal sound leakage suppression effect.

In one or more embodiments, the second leakage hole 17 is a strip-shaped hole adapted to the streamlined shape of the top wall 15.

In one or more embodiments, the top wall 15 has a streamlined structure, and the second leakage hole 17 is a strip-shaped hole adapted to the streamlined structure. Certainly, those skilled in the art may optimize the structure and size of the second leakage hole 17 according to the adjustment requirements of the absorption frequency and bandwidth of the second rear cavity 132. Further, the second leakage hole 17 faces forward of the user to avoid the two first leakage holes 14 arranged in the vertical direction as much as possible.

In one or more embodiments, a slot 161 is arranged along the edge of one of the top wall 15 or the bottom wall 16, and an insertion plate 151 is arranged along the edge of the other one of the top wall 15 or the bottom wall 16; the insertion plate 151 is inserted into the slot 161.

In one or more embodiments, the fit between the insertion plate 151 and the slot 161 can ensure the sealing of the housing 1 of the headphone and prevent the service life of the open-back headphone from being affected due to dust or other impurities entering the open-back headphone. Moreover, this can also prevent the sound from leaking through the gap between the top wall 15 and the bottom wall 16 to a certain extent.

Further, an antistatic coating is convexly arranged on the outer wall of the housing 1, or the housing 1 is made of an antistatic material. The surface of the housing 1 may be made of an immersion or super immersion material, which is convenient for cleaning and sweat discharge. Moreover, the housing 1 is directly made of the antistatic material or coated with the antistatic coating, which can prevent pollutants from adhering to the outer wall of the housing 1, thereby preventing the open-back headphone from being blocked and ensuring the cleanliness of the open-back headphone.

What is claimed is:

1. An open-back headphone, comprising:
a housing, wherein the housing is provided with a guide portion facing an ear canal of a user, and the guide portion is configured to project a sound wave into the ear canal; an interior of the housing comprises a front cavity facing the guide portion and a rear cavity facing away from the guide portion; and
a circuit board, wherein the circuit board is located within the rear cavity and separates the rear cavity into a first rear cavity and a second rear cavity, and the first rear cavity is adjacent to the front cavity; the circuit board is provided with a through hole for communicating the first rear cavity with the second rear cavity, and the through hole and the second rear cavity are arranged to form a Helmholtz resonance effect to absorb a resonant sound wave generated by the first rear cavity.

2. The open-back headphone according to claim 1, wherein the housing is provided with a first leakage hole communicating with the first rear cavity; a damping mesh is built into the first leakage hole.

3. The open-back headphone according to claim 2, wherein N first leakage holes are provided, N≥2, and the plurality of first leakage holes are spaced apart from each other.

4. The open-back headphone according to claim 3, wherein the housing is provided with two first leakage holes of the plurality of first leakage holes; when the open-back headphone is in a worn state, one of the two first leakage holes is arranged to face upward, and the other one of the two first leakage holes is arranged to face downward.

5. The open-back headphone according to claim 2, wherein the housing comprises a top wall and a bottom wall; the guide portion is arranged on the bottom wall, and the first leakage hole is arranged on the top wall.

6. The open-back headphone according to claim 1, wherein the housing is provided with a second leakage hole communicating with the second rear cavity; a damping mesh is built into the second leakage hole.

7. The open-back headphone according to claim 6, wherein when the open-back headphone is in a worn state, the second leakage hole is arranged to face forward of the user.

8. The open-back headphone according to claim 6, wherein the housing comprises a top wall and a bottom wall; the guide portion is arranged on the bottom wall, and the second leakage hole is arranged on the top wall.

9. The open-back headphone according to claim 8, wherein the second leakage hole is a strip-shaped hole adapted to a streamlined shape of the top wall.

10. The open-back headphone according to claim 5, wherein a slot is arranged along an edge of one of the top wall or the bottom wall, and an insertion plate is arranged along an edge of the other one of the top wall or the bottom wall; the insertion plate is inserted into the slot.

11. The open-back headphone according to claim 8, wherein a slot is arranged along an edge of one of the top wall or the bottom wall, and an insertion plate is arranged along an edge of the other one of the top wall or the bottom wall; the insertion plate is inserted into the slot.
